(19) United States
(12) Patent Application Publication
(10) Pub. No.: US 2012/0079311 A1
(43) Pub. Date: Mar. 29, 2012

(54) STORAGE PROCESSING DEVICE AND FAILOVER CONTROL METHOD

(75) Inventors: Satoru Goto, Nagoya-shi (JP); Yukihito Hara, Nagoya-shi (JP)

(73) Assignee: Buffalo Inc., Nagoya-shi (JP)

(21) Appl. No.: 13/228,725

(22) Filed: Sep. 9, 2011

(30) Foreign Application Priority Data
Sep. 28, 2010 (JP) 2010-217435

(51) Int. Cl. G06F 11/00

(52) U.S. Cl. 714/4.11; 714/E11.009

(57) ABSTRACT

A storage processing device to which a storage medium is connectable configures a failover system together with a different storage processing device. The storage processing device sets information obtained from predetermined random information as identification information of the storage medium, at the start to configure the failover system.

### CROSS REFERENCE TO RELATED APPLICATION

This application is based upon and claims the benefit of priority from the prior Japanese Patent Application No. 2010-217435 filed on Sep. 28, 2010; the entire contents of which are incorporated herein by reference.

### BACKGROUND OF INVENTION

1. Field of Invention

This invention relates to a storage processing device to which a storage medium is connectable and which configures a failover system together with a different storage processing device, and to a failover control method in the storage processing device.

2. Descriptions of the Related Art

Heretofore, some systems have employed a failover configuration to improve the reliability of the systems. In a system employing the failover configuration (failover system), for example, one of two servers serves as a main and the other serves as a backup. The main server performs processing for tasks under normal conditions, and the backup server takes over the processing for the tasks when the main server fails.

In recent years, storage processing devices called network attached storages (NAS) have been widely used. Plural storage media can be connected to the NAS, and various types of content data such as video and audio data can be stored in the storage media. Upon receiving a request for content data from a terminal device via a network, the NAS transmits the requested content data to the terminal device via the network. The terminal device reproduces the content of the received content data.

A proposal has been made to build a failover configuration fora system using NAS. Ina failover system including two NAS, one NAS is the main and the other NAS is the backup. As similar to the above system, the main NAS performs processing for tasks under normal conditions, and the backup NAS takes over the processing for the tasks when the main NAS fails.

The failover system performs synchronization or the like of user data stored in the storage media connected to the NAS. Thus, each of the storage media needs to be identified. Conventionally, a media access control (MAC) address assigned to a communication unit such as a LAN card in each NAS has been used as identification information of a storage medium (for example, see Japanese Patent Application Publication No. 2008-140198).

### SUMMARY OF INVENTION

Storage media connected to the NAS are hard disks or the like, and are detachably attached to the NAS. Thus, a storage medium connected to one NAS can be replaced with another storage medium. In this case, the plural storage media may be given the same MAC address as the identification information. Moreover, every time the NAS to which a storage medium is connected changes to another NAS, the identification information of the storage medium also changes. If the identification information of the storage medium is frequently changed as described above, a problem is likely to occur that the identification information, recognized by the main NAS, of the storage medium connected to the backup NAS, or the identification information, recognized by the backup NAS, of the storage medium connected to the main is different from the actual identification information.

In view of the problem described above, an object of this invention is to provide a storage processing device and a failover control method capable of setting appropriate identification information to a storage medium.

According to one of the features of this invention, there is provided a storage processing device to which a storage medium is connectable and which configures a failover system together with a different storage processing device, the storage processing device comprising: a setting unit for setting information obtained from predetermined random information as identification information of the storage medium, at the start to configure the failover system.

The storage processing device described above sets information obtained from the predetermined random information as the identification information of the storage medium connected thereto, at the start to configure the failover system together with a different storage processing device. Accordingly, the storage processing device can prevent the same identification information from being assigned to plural storage media. Furthermore, the storage processing device serving as either of the main and the backup can be prevented from recognizing identification information different from actual one as the identification information of a storage medium connected to its counterpart device, that is, the backup or the main.

According to another feature of this invention, the setting unit stores the identification information of the storage medium in a predetermined region in a storage area of the storage medium if the identification information of the storage medium is not set.

According to another feature of this invention, the storage processing device further comprises a communication processor for performing communication with the different storage processing device by using the identification information set by the setting unit while the configuration of the failover system is working.

According to another feature of this invention, the communication processor stops the use of the identification information set by the setting unit if the failover system is unconfigured.

According to one of the features of this invention, there is provided a failover control method in a storage processing device to which a storage medium is connectable and which configures a failover system together with a different storage processing device, the failover control method comprising: the step of setting information obtained from predetermined random information as identification information of the storage medium, at the start to configure the failover system.

### BRIEF DESCRIPTION OF DRAWINGS

FIG. 1 is an overall structural diagram of a storage system of an embodiment of this invention.

FIG. 2 is a structural diagram of a NAS of the embodiment of this invention.

FIG. 3 is a structural diagram of a storage area of a hard disk of the embodiment of this invention.

FIG. 4 is a flowchart of a first operation of the NAS of the embodiment of this invention.

FIG. 5 is a flowchart of a second operation of the NAS of the embodiment of this invention.

### DESCRIPTION OF EMBODIMENTS

An embodiment of the present invention will be described with reference to the drawings. The structure of a storage system, the structure of a NAS, the operation of the NAS, the obtained results, and other embodiments will be described. In the drawings of the embodiment below, the same or similar components are labeled with the same or similar reference numerals.

(1) Configuration of Storage System

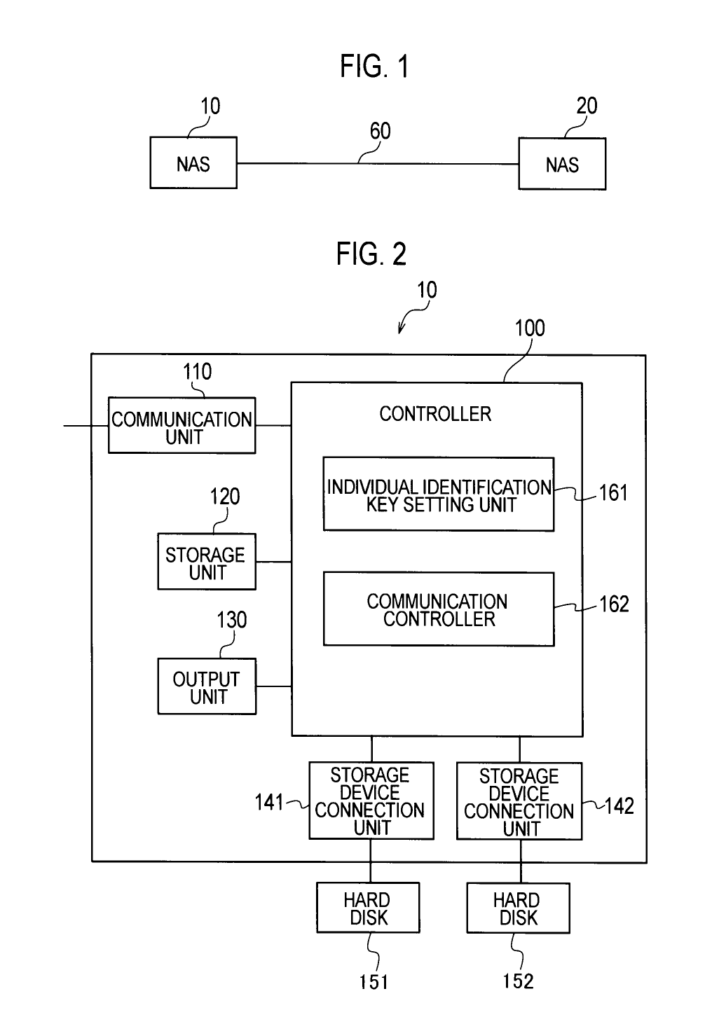

FIG. 1 is an overall structural diagram of the storage system. The storage system shown in FIG. 1 includes a network attached storage (NAS) 10 and a NAS 20 which are storage processing devices, and a communication line 60 connecting the NAS 10 and the NAS 20 to each other.

In the storage system of the embodiment, when a failover system includes the NAS 10 and the NAS 20, one of the NAS 10 and the NAS 20 is a main and the other is a backup. Moreover, settings and data are synchronized between the NAS 10 and the NAS 20. In this configuration, the main NAS performs processing for tasks under normal conditions, and the backup NAS takes over the processing for the tasks when the main NAS fails.

(2) Configuration of NAS

FIG. 2 shows a structure of the NAS 10. Note that, the NAS 20 also has the similar structure. The NAS 10 shown in FIG. 2 includes a controller 100, a communication unit 110, a storage unit 120, a storage device connection unit 141, and a storage device connection unit 142.

The controller 100 is, for example, a CPU, and controls various functions which the NAS 10 has.

The communication unit 110 is, for example, a LAN card, and a media access control (MAC) address is assigned thereto. The communication unit 110 is a communication interface for communicating with the outside, and communicates with the NAS 20 via the communication line 60.

The storage unit 120 is, for example, a NAND flash memory, and stores various types of information used for the control of the NAS 10. The storage unit 120 stores various types of setting information required to configure the failover system. The storage device connection unit 141 is used to connect a hard disk 151. The storage device connection unit 142 is used to connect a hard disk 152. The hard disk 151 and the hard disk 152 form a RAID configuration, and store data to be synchronized between the main and the backup such as user data.

The controller 100 includes an individual identification key setting unit 161 and a communication controller 162.

When the NAS 10 and the NAS 20 start to configure the failover system, a first processing described below is performed. While the NAS 10 and the NAS 20 are serving as the configuration of the failover system, a second processing described below is performed. Furthermore, when the NAS 10 and the NAS 20 unconfigure the failover system, a third processing described below is performed.

(First Processing) The controller 100 judges whether or not the hard disk 151 is connected to the storage device connection unit 141 and the hard disk 152 is connected to the storage device connection unit 142. In order for the NAS 10 to configure the failover system, the hard disk 151 needs to be connected to the storage device connection unit 141 and the hard disk 152 needs to be connected to the storage device connection unit 142.

When the NAS 10 and the NAS 20 start to configure the failover system as the main and the backup, respectively, the controller 100 generates configuration start notification information for notifying the NAS 20 of the start to configure the failover system. Then, the controller 100 outputs the configuration start notification information to the communication unit 110. The communication unit 110 transmits the inputted configuration start notification information to the NAS 20 via the communication line 60.

On the other hand, when the NAS 10 and the NAS 20 start to configure the failover system, as the backup and the main, respectively, the NAS 20 transmits the configuration start notification information to the NAS 10. In this case, the communication unit 110 receives the configuration start notification information from the NAS 20 via the communication line 60, and outputs the configuration start notification information to the controller 100.

The individual identification key setting unit 161 performs the following processing under conditions in which the hard disks 151 and 152 are connected to the storage device connection units 141 and 142, respectively, and in which the configuration start notification information is transmitted to the NAS 20 or is received from the NAS 20.

The individual identification key setting unit 161 judges whether or not the individual identification key as the identification information of the hard disk 151 is stored in an identification information setting region as a predetermined region in the storage area of the hard disk 151. In a similar manner, the individual identification key setting unit 161 judges whether or not the individual identification key as the io identification information of the hard disk 152 is stored in an identification information setting region as a predetermined region in the storage area of the hard disk 152.

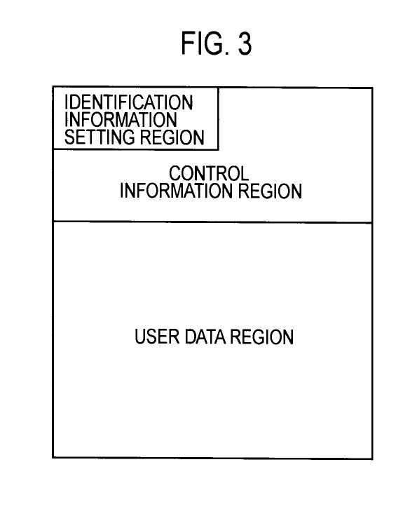

FIG. 3 shows an exemplar structure of a storage area of the hard disk 151 and the hard disk 152. When each of the hard disk 151 and the hard disk 152 is formatted, the storage area thereof is provided with a control information region and a user data region. Furthermore, the identification information setting region as the region for storing the individual identification key is provided in a predetermined region in the control information region.

If at least one of the hard disk 151 and the hard disk 152 is not storing the individual identification key in the identification information setting region thereof, the individual identification key setting unit 161 sets the individual identification key for the hard disk (setting target hard disk) not storing the individual identification key.

The individual identification key setting unit 161 sets the information obtainable from predetermined random information, as the individual identification key. Here, the predetermined random information is a random character string, and the individual identification key setting unit 161 sets, for example, information obtained by combining the MAC address assigned to the communication unit 110 and the random character string, as the individual identification key. Then, the individual identification key setting unit 161 writes the set individual identification key in the identification information setting region of the setting target hard disk.

Meanwhile, the individual identification key setting unit 161 does not set and store the individual identification key for the hard disk in which the individual identification key in the identification information setting region is already stored, among the hard disk 151 and the hard disk 152.

The controller 100 reads the individual identification key stored in the identification information setting region of each of the hard disk 151 and the hard disk 152. Then, the controller 100 outputs the read individual identification key of the hard disk 151 and individual identification key of the hard disk 152 to the communication unit 110. The communication unit 110 transmits the inputted individual identification key of the hard disk 151 and individual identification key of the hard disk 152 to the NAS 20 via the communication line 60.

Meanwhile, the NAS 20 also sends the NAS 10 the individual identification keys of the hard disks connected to the NAS 20. The communication unit 110 receives the individual identification keys of the hard disks connected to the NAS 20, via the communication line 60. Then, the communication unit 110 outputs the individual identification keys of the hard disks connected to the NAS 20, to the controller 100. The controller 100 stores the inputted individual identification keys of the hard disks connected to the NAS 20, in the storage unit 120. The NAS 10 and the NAS 20 exchange individual identification keys therebetween as described above, and thus can configure the failover system.

(Second Processing)

When the NAS 10 serving as the main and the NAS 20 synchronize user data therebetween, the communication controller 162 reads the user data (synchronization target user data) requiring synchronization from the hard disk 151 and the hard disk 152. Then, the communication controller 162 reads the individual identification key of the hard disk in which the synchronization target user data is stored, from the storage unit 120, and adds the individual identification key to the synchronization target user data. Next, the communication controller 162 outputs the synchronization target user data added with the individual identification key to the communication unit 110. The communication unit 110 transmits the synchronization target user data added with the individual identification key to the NAS 20 via the communication line 60.

Meanwhile, when the NAS 10 serving as the backup and the NAS 20 synchronize user data therebetween, the NAS 20 transmits the synchronization target user data added with the individual identification key to the NAS 10 via the communication line 60.

In this case, the communication unit 110 in the NAS 10 receives the synchronization target user data added with the individual identification key, and outputs the synchronization target user data to the controller 100. When the synchronization target user data added with the individual identification key is inputted, the controller 100 performs processing such as determining the hard disk in which the synchronization target user data is to be stored, on the basis of the individual identification key.

(Third Processing)

When the NAS 10 serving as the main and the NAS 20 serving as the backup unconfigure the failover system, the controller 100 generates unconfiguration notification information for notifying the NAS 20 of the unconfiguration of the failover system. Then, the controller 100 outputs the unconfiguration notification information to the communication unit 110. The communication unit 110 transmits the inputted unconfiguration notification information to the NAS 20 via the communication line 60.

Meanwhile, when the NAS 10 serving as the backup and the NAS 20 serving as the main unconfigure the failover system, the NAS 20 transmits the unconfiguration notification information to the NAS 10. In this case, the communication unit 110 receives the unconfiguration notification information from the NAS 20 via the communication line 60, and outputs the unconfiguration notification information to the controller 100.

When the unconfiguration notification information is transmitted to the NAS 20 or is received from the NAS 20, the individual identification key setting unit 161 deletes the individual identification key of the hard disk 151 which is stored in the identification information setting region of the hard disk 151. Similarly, the individual identification key setting unit 161 deletes the individual identification key of the hard disk 152 which is stored in the identification information setting region of the hard disk 152. Thus, no individual identification keys are set for the hard disk 151 and the hard disk 152.

(3) Operation of NAS

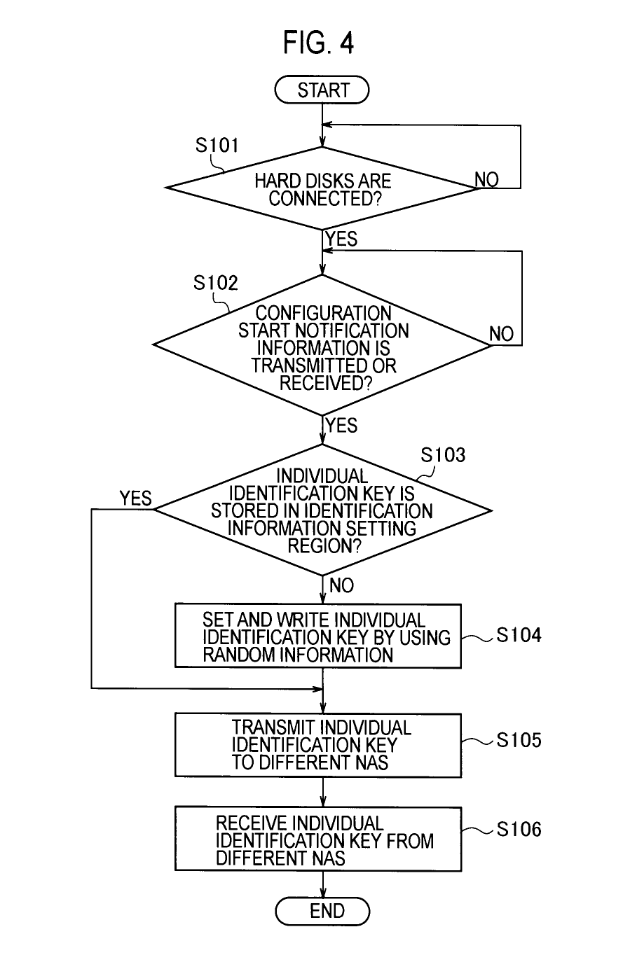

FIG. 4 is a flowchart of an operation of the NAS 10 at the start to configure the failover system.

In Step S101, the NAS 10 judges whether or not the hard disk 151 and the hard disk 152 are connected to the NAS 10.

If the hard disk 151 and the hard disk 152 are connected, the NAS 10 judges whether the configuration start notification information is transmitted to the NAS 20 or is received from the NAS 20, in Step S102.

If the configuration start notification information is transmitted or received, the NAS 10 judges whether or not the individual identification key is stored in the identification information setting region of each of the hard disk 151 and the hard disk 152, in Step S103.

When at least one of the hard disk 151 and the hard disk 152 is not storing the individual identification key in the identification information setting region thereof, the NAS 10 sets the individual identification key for the hard disk (setting target hard disk) not storing the individual identification key, by using the random information, in Step S104. Then, the NAS 10 writes the set individual identification key in the setting target hard disk.

After Step S104 or if it is judged in Step S103 that the individual identification keys are stored in the identification information setting regions of both of the hard disk 151 and the hard disk 152, the NAS 10 transmits the individual identification key of the hard disk 151 and the individual identification key of the hard disk 152 to the NAS 20, in Step S105.

In Step S106, the NAS 10 receives the individual identification keys of the hard disks connected to the NAS 20, from the NAS 20.

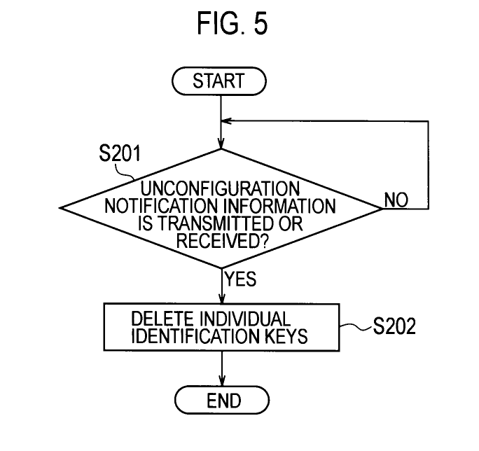

FIG. 5 is a flowchart of an operation of the NAS 10 in unconfiguring the failover system.

In Step 201, the NAS 10 judges whether the unconfiguration notification information is transmitted to the NAS 20 or is received from the NAS 20.

If the unconfiguration notification information is transmitted or received, the NAS 10 deletes the individual identification keys in the identification information setting regions of the hard disk 151 and the hard disk 152, in Step S202.

(4) Obtained Results

In the storage system of the embodiment, when the configuration start notification information is transmitted to the NAS 20, i.e. when the NAS 10 and the NAS 20 start to configure of the failover system, the NAS 10 sets the individual identification keys of the hard disks connected to the NAS 10, and stores the individual identification keys in the identification information setting regions. However, if the individual identification key is already stored in the identification information setting region of the hard disk 151 connected to the NAS 10, the NAS 10 does not set and store the individual identification key. Moreover, in unconfiguring the failover system, the NAS 10 deletes the individual identification keys stored in the identification information setting regions of the hard disks connected to the NAS 10.

The setting of information obtained from random information as individual identification keys prevents plural hard disks from being assigned the same individual identification key. Moreover, while the NAS 10 and the NAS 20 are serving as the configuration of the failover system, the individual identification key of the hard disk 151 is fixed. Thus, in each of the main NAS and the backup NAS, it is possible to prevent the problem that the identification information of the storage medium connected to the other party is recognized differently from the actual identification information.

(5) Other Embodiments

As described above, the details of this invention have been disclosed by using the embodiments of this invention.

However, it should not be understood that the description and drawings which constitute part of this disclosure limit this invention. From this disclosure, various alternative embodiments, examples, and operation techniques will be easily found by those skilled in the art.

In the embodiment described above, the main NAS and the backup NAS each set the individual identification keys, and exchange the individual identification keys therebetween. However, it may be configured that at least one of the main NAS and the backup NAS generates one individual identification key and stores the one individual identification key.

In the above embodiment, the NAS 10 regards the transmission or reception of the configuration start notification information as the start to configure the failover system. However, the NAS 10 may regard the transmission or reception of other information, or the execution of certain processing, as the start to configure the failover system. Moreover, the NAS 10 may regard the transmission or reception of information other than the unconfiguration notification information as the unconfiguration of the failover system, or may regard the execution of certain processing as the unconfiguration of the failover system.

In the above embodiment, the hard disk is connected to the NAS 10. However, the storage medium to be connected is not limited to this. For example, a storage medium such as a solid state drive (SSD) , a flash memory, or a SD card may be connected.

In this manner, this invention naturally includes various embodiments not specifically described herein.

What is claimed is:

1. A storage processing device to which a storage medium is connectable and which configures a failover system together with a different storage processing device, the storage processing device comprising:
a setting unit for setting information obtained from predetermined random information as identification information of the storage medium, at the start to configure the failover system.

2. The storage processing device according to claim 1 wherein
the setting unit stores the identification information of the storage medium in a predetermined region in a storage area of the storage medium if the identification information of the storage medium is not set.

3. The storage processing device according to claim 1 further comprising:
a communication processor for performing communication with the different storage processing device by using the identification information set by the setting unit while the configuration of the failover system is working.

4. The storage processing unit according to claim 3 wherein
the communication processor stops the use of the identification information set by the setting unit if the failover system is unconfigured.

5. A failover control method in a storage processing device to which a storage medium is connectable and which configures a failover system together with a different storage processing device, the failover control method comprising:
the step of setting information obtained from predetermined random information as identification information of the storage medium, at the start to configure the failover system.
